(19) United States
(12) Patent Application Publication
(10) Pub. No.: US 2002/0138680 A1
(43) Pub. Date: Sep. 26, 2002

(54) Apparatus and methods for controlling removable media devices using a BIOS abstraction layer

(76) Inventor: Curtis E. Stevens, Irvine, CA (US)

Correspondence Address: Claudia Cameron, Phoenix Technologies Ltd., 411 East Plumeria Drive, San Jose, CA, 95134, US

(21) Appl. No.: 09/813,070

(22) Filed: Mar. 20, 2001

(51) Int. Cl. G06F 13/24

(52) U.S. Cl. 710/260

(57) ABSTRACT

Apparatus and methods that control removable media devices, such as CD-ROM, DVD and magneto-optical devices, and the like, using an abstraction layer in firmware (BIOS). The apparatus and methods provide for communication with CD-ROM, DVD, magneto-optical, and other removable media devices so that they are bootable regardless of the primary or secondary bus used to interface them to the computer system. Exemplary apparatus and methods comprise one or more abstraction layers in the system firmware that employ interrupt 13h functions to allow a program, such as an operating system or application, to communicate with the removable media device. The removable media employed with the removable media device comprises an operating system, a file system driver, a device driver that calls the abstraction layer in the BIOS, and one or more applications. The removable media employed with the removable media device may be preferably used to perform recovery of contents of a device coupled to the computer.

### BACKGROUND

The present invention relates generally to computer systems and methods, and more particularly, to computer systems and methods that control removable media devices using a BIOS abstraction layer.

The basic input/output system (BIOS) developed by the assignee of the present invention is currently able to provide services to hard drives using Int 13. NCITS-347 (BIOS Enhanced Disk Drive Services) provides a description of some of these services.

A common practice today is to use a bus specific driver to control a CD-ROM device. The bus specific CD-ROM driver can then provide services to a driver that provides CD-ROM file system services to an operating system. The most popular personal computer bus-specific driver provides access to an ATAPI (AT Attachment Packet Interface) CD-ROM drive.

In the case of an El Torito bootable CD-ROM or DVD (El Torito is a public specification that is posted on a web site (www.Phoenix.com) of the assignee of the present invention, for example), the BIOS can boot the operating system as a simulated floppy disk. The simulated floppy disk normally boots a version of a disk operating system (DOS), such as MS-DOS, installs an ATAPI CD-ROM driver (ATAPI.SYS), and then installs a file system driver (for example MSCDEX.EXE). The file system driver then provides a drive letter, D:, for example, that points to the data on the CD-ROM media.

The prior art practice has worked successfully on systems since 1995 because ATAPI has been a standard for interfacing CD-ROM and DVD devices. The first 1394 CD-ROM drives were introduced around 1998. Later, USB™ CD-ROM and DVD drives started to become popular as well. There have been SCSI CD-ROM drives for a long time, but they have been less of an issue because they use an option ROM to provide CD-ROM boot services. The problem today is that CD-ROM media that contain ATAPI drivers will boot on all the newly developed buses, but when the ATAPI driver installs a failure occurs. This failure happens because the CD-ROM drive is not on an ATAPI bus.

As a result of the above stated failure, there are manufacturing and support problems for PC system integrators. In particular, manufacturers of notebook computer systems are moving away from the use of ATAPI CD-ROM drives and are using USB or 1394 buses to connect external CD-ROM drives. The use of multiple host buses creates a problem: manufacturers would like to use a single media for all the buses on which their CD-ROM drives reside.

It is an objective of the present invention to provide for computer apparatus and methods that control CD-ROM, DVD and other removable media devices by using a BIOS abstraction layer. It is also an objective of the present invention to provide for computer apparatus and methods that overcomes problems associated with computers that do not use a standard ATAPI interface for CD-ROM, DVD and other removable media devices.

### SUMMARY OF THE INVENTION

To accomplish the above and other objectives, the present invention provides for computer apparatus and methods for controlling removable media devices, such as CD-ROM, DVD and magneto-optical devices, and the like, using an abstraction layer in firmware (for example: BIOS). The apparatus and methods provide for communication with CD-ROM, DVD, magneto-optical, and other removable media devices so that they are bootable regardless of the primary or secondary bus used to interface them to the computer system.

Exemplary apparatus and methods control a removable media device coupled by way of a bus interface to a computer system having a basic input/output system (BIOS). The apparatus and methods comprise one or more abstraction layers in the BIOS that employ interrupt 13h functions to allow a program, such as an operating system or application, to communicate with the removable media device. The removable media employed with the removable media device comprises an operating system, a file system driver, a device driver that calls the abstraction layer in the BIOS, and one or more applications. The removable media employed with the removable media device may be preferably used to perform recovery of contents of a device coupled to the computer.

The present invention uses a generic device driver to control the removable media device. The generic device driver makes calls to an interface (the abstraction layer) in the BIOS (system firmware) of the computer system to access the removable media device. In particular, the interface employs interrupt (Int) 13 function 42h and 48h calls to interface the generic device driver to the removable media device.

The present invention allows a CD-ROM, DVD, magneto-optical or other removable media device to boot from an operating system contained on the media and then provides access to all the data on the media, regardless of the bus interface. The bus interface bus may be a USB™ (Universal Serial Bus), IEEE-1394, Bluetooth™ (short-range radio technology), ATA (AT Attachment), ATAPI, SCSI (small computer system interface), PCI® (Peripheral Component Interconnect), or Infiniband™ buses.

### BRIEF DESCRIPTION OF THE DRAWINGS

The various features and advantages of the present invention may be more readily understood with reference to the following detailed description taken in conjunction with the accompanying drawing, wherein like reference numerals designate like structural elements, and in which:

FIG. 1 is a block diagram showing components of a typical computer system that employs the present invention;

FIG. 2 illustrates the architecture of an exemplary removable media device;

FIG. 3 is a flow diagram illustrating a power-on-self-test (POST) procedure in accordance with the principles of the present invention;

FIG. 4 is a flow diagram illustrating a boot procedure that occurs after the POST procedure illustrated in FIG. 3;

FIG. 5 is a flow diagram that illustrates conventional access to an ATAPI CD-ROM drive implemented in a computer system;

FIG. 5a is a flow diagram that illustrates a conventional procedure for opening a file;

FIG. 5b is a flow diagram that illustrates details of the conventional procedure for opening a file shown in FIG. 5a;

FIG. 6 is a flow diagram that illustrates access to a removable media device implemented in accordance with the principles of the present invention;

FIG. 6a is a flow diagram that illustrates a procedure in accordance with the principles of the present invention for opening a file; and

FIG. 6b is a flow diagram that illustrates details of the present procedure for opening a file shown in FIG. 6a.

### DETAILED DESCRIPTION

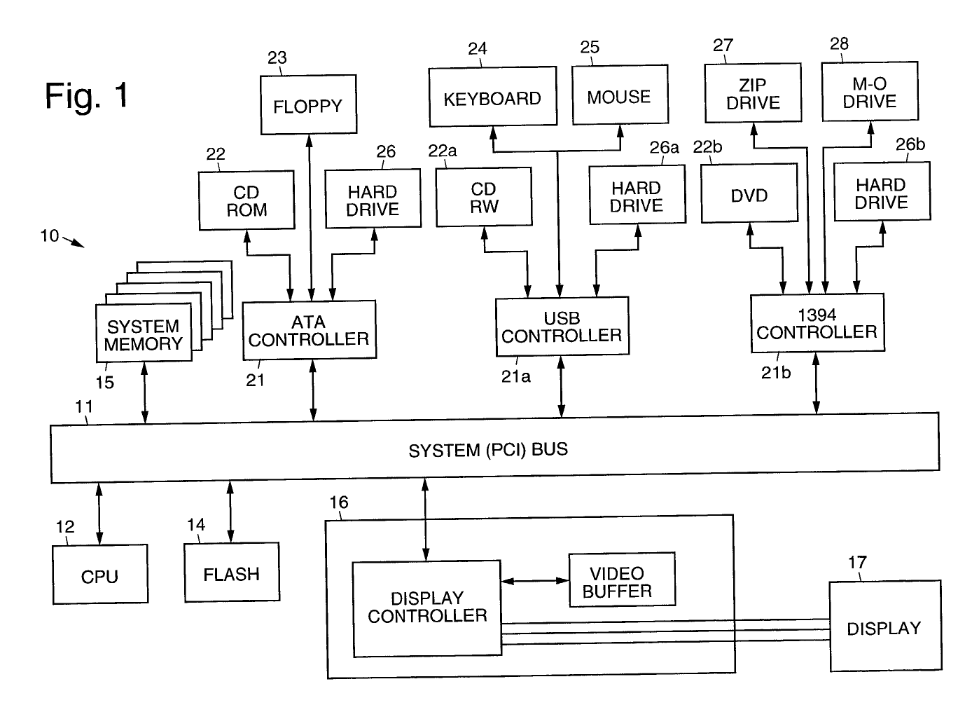

Referring to the drawing figures, FIG. 1 is a block diagram showing components of a typical computer system 10 in which the present invention is employed. The computer system 10 includes a system bus 11 which connects the different components of the computer system 10 including a central processing unit (CPU) 12, a flash device 14, and a main or system memory 15. A data display device 17 is connected to the system bus 11 by way of a video controller 16 that typically includes a video buffer.

A plurality of removable media device controllers 21, 21a, 21b are also connected to the system bus 11. Three device controllers 21, 21a, 2lb are shown which include an ATA controller 21, a universal system bus (USB) controller 21a and an IEEE-1394 controller 21b.

The ATA controller 21 is coupled to an ATAPI CD-ROM device 22, a floppy disk drive 23 and an ATAPI hard disk drive 26. The USB controller 21a is coupled to a USB CD-Read/Write (CD-RW) device 22a, a keyboard 24, a mouse 25 and a USB hard disk drive 26a. The IEEE-1394 controller 21b is coupled to an IEEE-1394 DVD device 22b, a IEEE-1394 hard disk drive 26b, a Zip drive 27 and a magneto-optical (M-O) drive 28.

Data, including multimedia data, may be stored in any of the removable media devices 22, 22a, 22b, 27, 28 which data can be accessed by the CPU 12 through the associated removable media device controller 21, 21a, 21b. Other data, stored in the floppy disk drive 23 or hard disk drives 26, 26a, 26b can also be accessed by the CPU 12 through the corresponding device controllers 21, 21a, 21b.

Conventional computer systems 10 typically use the ATA controller 21 and associated ATAPI CD-ROM device 22. Such conventional computer systems 10 include ATAPI device drivers but do not contain additional drivers to support the non-ATAPI devices 22a, 22b. In the event that a user replaces or adds a removable media device 22a, 22b that is not an ATAPI CD-ROM device 22, if the user boots from the newly added device, the system will lock up. Furthermore, in the event that a user attempts to boot and run a recovery program from the newly added device, the hard disk drive 26 that is to be recovered may be erased and the data contained therein destroyed without the knowledge of the user. The present invention minimizes these potential problems.

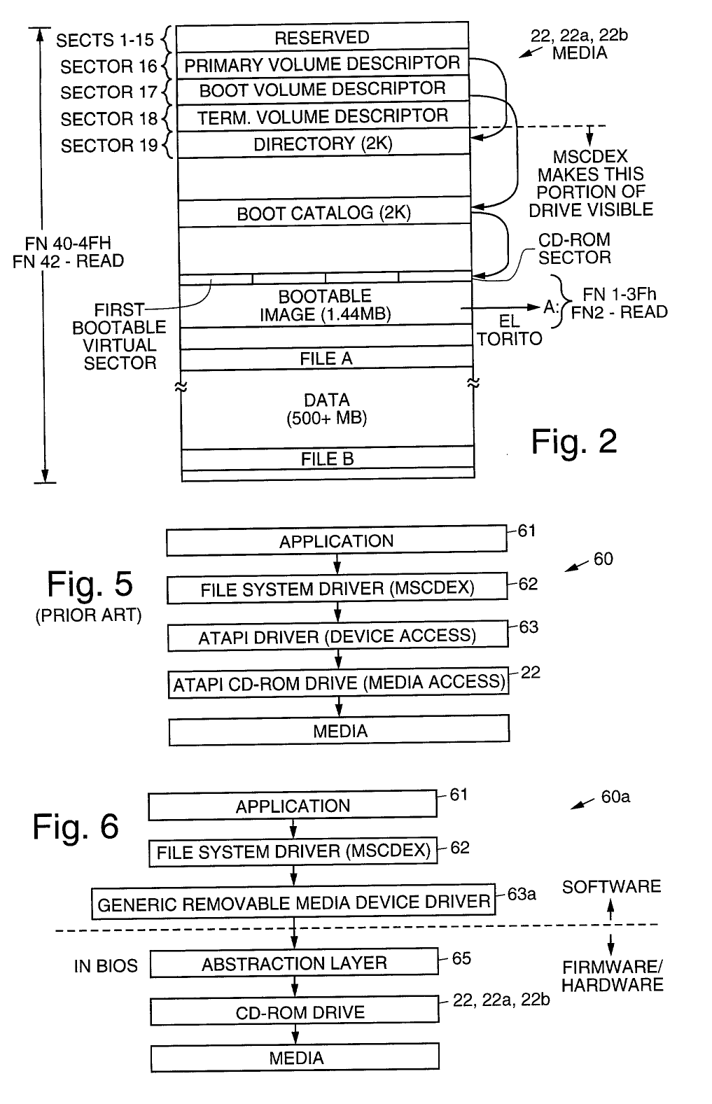

FIG. 2 illustrates the architecture of media of an exemplary removable media device 22, 22a, 22b, and in particular, a CD-ROM device. The removable media (CD-ROM) device 22, 22a, 22b has a reserved area in sectors 1-15, a primary volume descriptor in sector 16, a boot volume descriptor in sector 17, and a terminator volume descriptor in sector 18. The removable media (CD-ROM) device 22 has a directory in sector 19, which is a listing of files that are on the device 22. The directory has pointers to each of the files (catalog bootable image file A, file B, etc.). A file system driver (MSCDEX) makes the data from sector 19 visible and accessible to the operating system.

The primary volume descriptor points to the directory. The boot volume descriptor points to a boot catalog; the boot catalog then points to bootable image. The bootable image contains code that boots an operating system that is loaded into the system memory 15 of the computer system 10. The reserved area, the primary volume descriptor, the boot volume descriptor, the terminator volume descriptor and the directory each reside in 2 kilobyte size sectors. The boot catalog resides in a 2 kilobyte size sector. The bootable image is normally 1.44 megabyte in size and would then require 738 sectors. Data can be stored in sectors both above and below the bootable image. Typically the data storage portion of the CD-ROM device 22 is on the order of 600 megabytes in size. The Boot Volume Descriptor the boot catalog, and the bootable image are documented in the El Torito boot specification. The primary volume descriptor and terminator volume descriptor are described in the ISO-9660 standard. The CD-ROM sectors of the bootable image are broken up into four 512 kilobyte virtual sectors. This allows DOS based operating systems that normally use 512 byte sectors to function without modification.

By making the bootable image conform to the above-mentioned El Torito specification, the bootable image configures the removable media (CD-ROM) device 22 as a simulated floppy disk drive. Thus, the removable media (CD-ROM) device 22 is read as if it were a floppy disk drive. In addition, and in accordance with the principles of the present invention, the entire removable media (CD-ROM) device 22, 22a, 22b is readable using interrupt (Int) 42 BIOS READ calls.

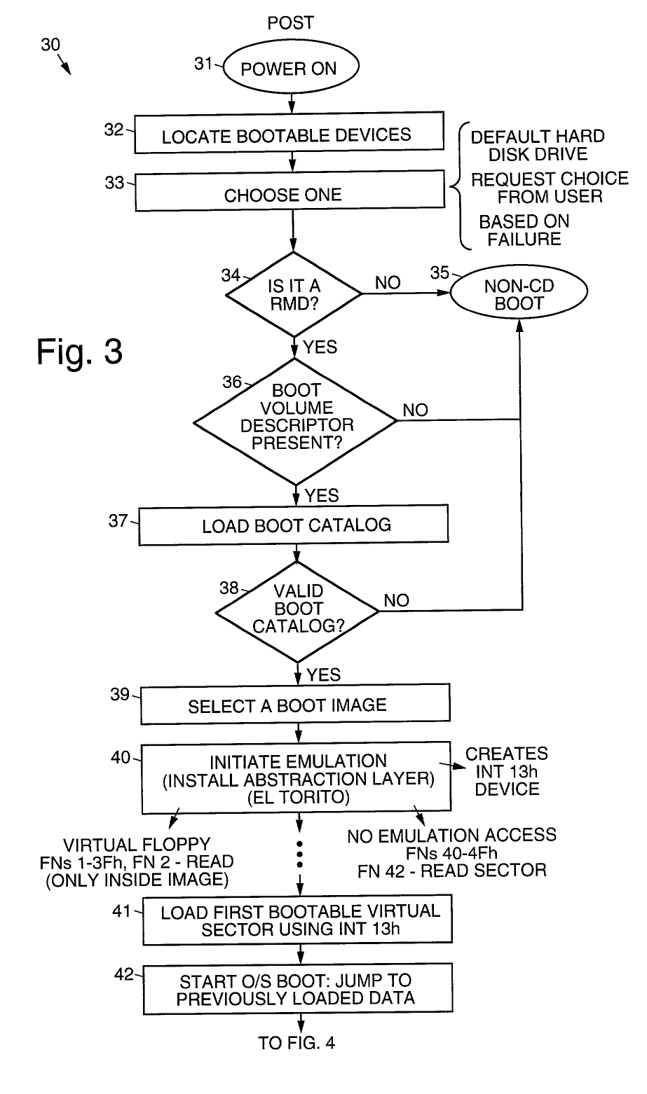

FIG. 3 is a flow diagram illustrating a power-on-self-test (POST) procedure 30 in accordance with the principles of the present invention. The computer system 10 is turned on 31. The system firmware (BIOS) locates 32 one or more bootable devices. One of the bootable devices is chosen 33. A determination 34 is made if the chosen device is a CD. If the chosen device is not a CD, a non-CD boot is performed 35 (such as from a floppy drive 23 or hard disk drive 26).

If the chosen device is a CD, it is determined 36 if the boot volume descriptor is present. If the boot volume descriptor is not present, a non-CD boot is performed 35. If the boot volume descriptor is present, the boot catalog is loaded 37. A determination 38 is made if there is a valid boot catalog. If there is not a valid boot catalog, a non-CD boot is performed 35 (such as from a floppy drive 23 or hard disk drive 26). If there is a valid boot catalog, a boot image is selected 39. Floppy disk emulation is initiated 40 (in accordance with the El Torito specification) which installs an abstraction layer 65 in accordance the present invention. The floppy disk emulation creates an Int 13h boot device.

The floppy disk emulation creates a virtual floppy and allows Int 13h functions (FNs) 1-3Fh, and in particular FN 2 (READ), to occur. Int 13h functions 1-3F only operate inside the boot image. The full CD can be accessed using functions 40-4Fh, and in particular to FN 42 (READ sector) calls.

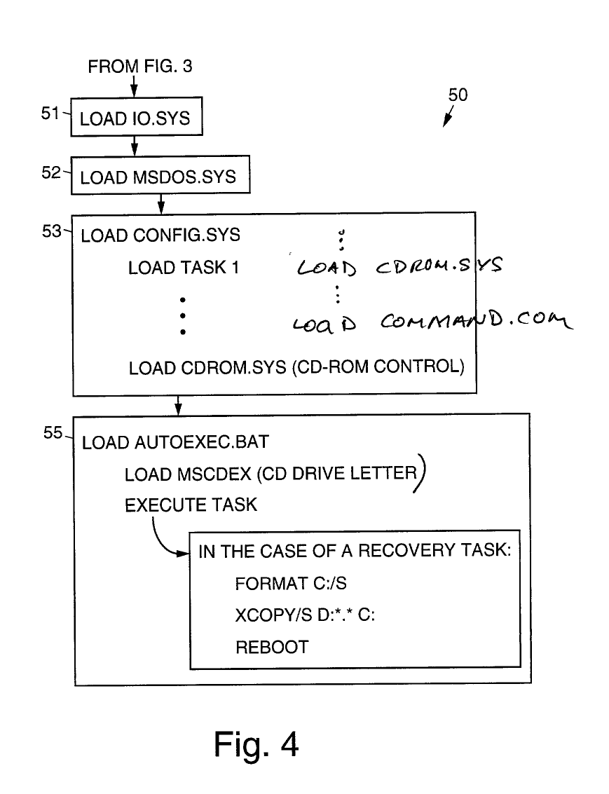

A number of other tasks may be performed after initiation 40 of the floppy disk emulation. Eventually, the first bootable virtual sector is loaded 41 into system memory 15 using Int 13h FN 2. Then, operating system (O/S) boot is started (executed) 42, by jumping to the previously loaded data. The process continues with reference to FIG. 4.

FIG. 4 is a flow diagram illustrating a boot procedure 50 that occurs after the POST procedure illustrated in FIG. 3. The code found in the first bootable virtual sector loads 51 IO.SYS. Then, MSDOS.SYS is loaded 52. Then, CONFIG.SYS is loaded 53. CONFIG.SYS eventually loads CDROM.SYS. The final task CONFIG.SYS performs is to begin executing COMMAND.COM

AUTOEXEC.BAT is then loaded 55. AUTOEXEC.BAT loads MSCDEX, which provides for a CD drive letter, and a task is executed. An exemplary task, and one that is part of a preferred embodiment of the present invention, is a recovery task. As part of the recovery task, a FORMAT C:/S command is issued. An XCOPY/S D:*.* C: command is issued. Finally a REBOOT command is issued to reboot the computer system 10.

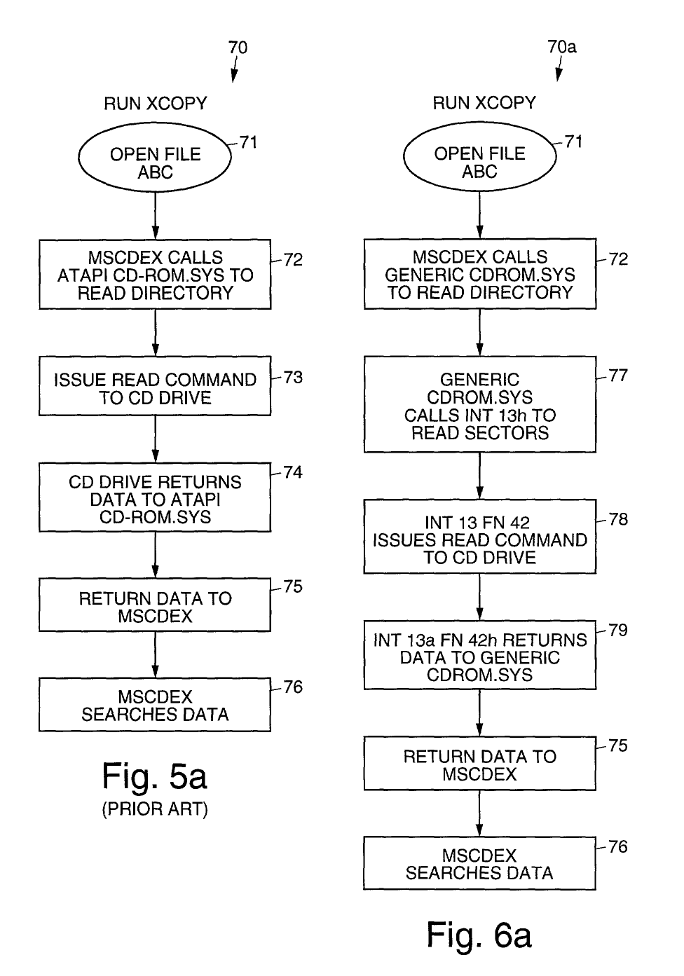

FIG. 5 is a flow diagram that illustrates a conventional operational environment 70 that provides access to an ATAPI CD-ROM drive 22 implemented in the computer system 10. In implementing conventional access to an ATAPI CD-ROM drive 22, an application, such as a restore program or DOS utility (XCOPY, FIG. 4, for example) is run 61. A file system driver (MSCDEX, for example) provides services 62 to the application. An ATAPI CD-ROM driver provides media access services 63 for media installed in the ATAPI CD-ROM device 22.

FIG. 5a is a flow diagram that illustrates a conventional procedure 70 that a program like MS-DOS XCOPY would use to open a file. In the conventional procedure 70, a command OPEN FILE: ABC is issued 71. ANSI standard NCITS 333 entitled “SCSI Multimedia Commands —2 (MMC—2)” provides CD-ROM commands that permit use of CD-ROM drives on ATAPI, USB, IEEE-1394 and other busses. In response to the OPEN FILE command, the file system driver (MSCDEX) calls 72 ATAPI CDROM.SYS which reads the directory of the CD-ROM device 73. The CD-ROM device returns 74 the directory data to ATAPI CDROM.SYS. The ATAPI CDROM.SYS drive returns 75 the data to the file system driver (MSCDEX). The file system driver (MSCDEX) searches 76 the data for the file and will return success or failure regarding the open function.

FIG. 5b is a flow diagram that illustrates details of the operation of ATAPI.SYS in the conventional file opening procedure 70 shown in FIG. 5a. In particular, the steps shown in FIG. 5b are performed by the ATAPI CDROM.SYS calls 72. The ATAPI CDROM.SYS open file call starts 81, and a request to read block X 82 into buffer Y is generated. An ATAPI READ command at address X into buffer Y is constructed 83. An ATAPI packet is sent 84 to the CD-ROM device. The CD-ROM device transfers 85 data to a buffer. The CD-ROM device signals 86 completion of the task. The read block X command returns 87 a complete signal.

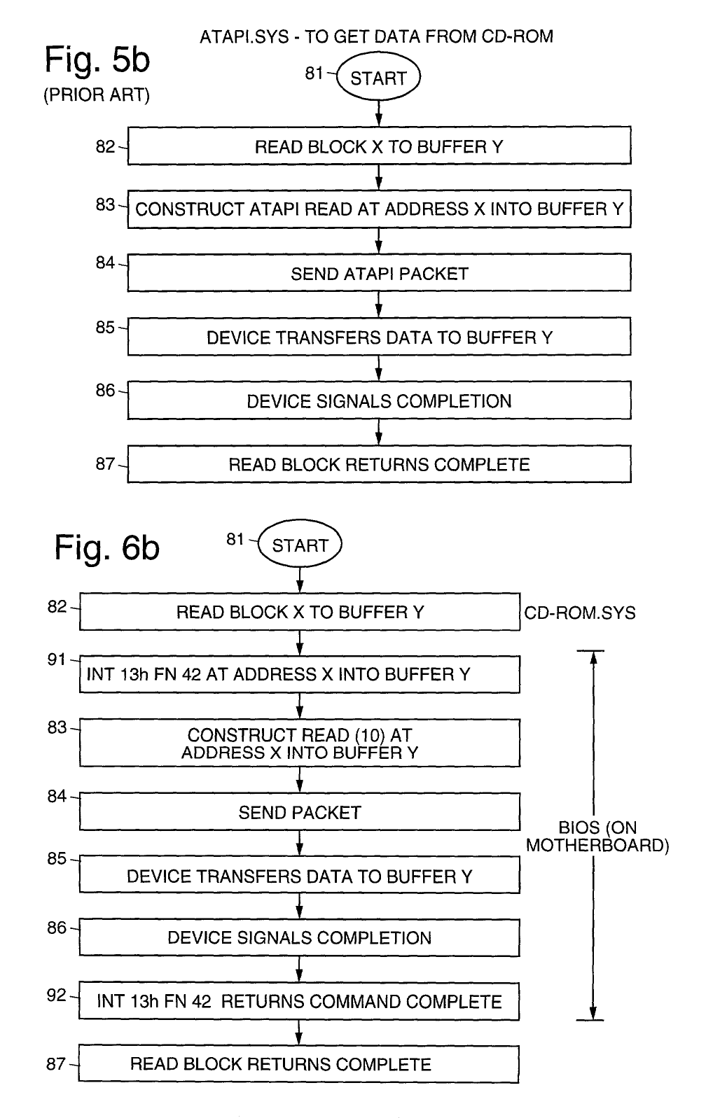

FIG. 6 is a flow diagram that illustrates an operational environment 60a that provides access to a removable media device in accordance with the principles of the present invention. The operational environment 60a starts by running 61 an application. A file system driver (MSCDEX, for example) provides services 62 to the application. A generic removable media device driver provides media access services 63 to the file system driver for media installed in the CD-ROM device 22, 22a, 22b, including CD-ROM, DVD, and magneto-optical devices. The generic removable media device driver then calls the Firmware (BIOS) abstraction layer 65, which provides low level access to media installed in the removable media device 22, 22a, 22b.

FIG. 6a is a flow diagram that illustrates a procedure 60a in accordance with the principles of the present invention that a program like MS-DOS XCOPY would use to open a file. In the present procedure 70a, a command OPEN FILE: ABC is issued 71. In response to the OPEN FILE command, the file system driver (MSCDEX) calls 72ageneric CDROM.SYS device driver to read the directory of the CD-ROM device. The generic CDROM.SYS device driver calls 77 interrupt (Int) 13h to read sectors of the CD-ROM device. An Int 13h function 42h issues 78 a READ command to the CD-ROM device. The CD-ROM device returns data which INT 13h FN 42h returns 79 to the generic CDROM.SYS driver. The generic CDROM.SYS driver returns 75 the data to the file system driver (MSCDEX). The file system driver (MSCDEX) searches 76 the data for the file and will return success or failure regarding the open function.

FIG. 6b is a flow diagram that illustrates details of the operation of CDROM.SYS in the procedure 70a shown in FIG. 6a. The steps shown in FIG. 6b are performed by the generic CDROM.SYS driver calls 76 and the Int 13h function 42 calls 77. The generic CDROM.SYS driver call starts 81 when a request to read block X 82 into buffer Y is received. An Int 13h function 42 at address X into buffer Y call 91 is made. A READ command at address X into buffer Y is constructed 83. A packet is sent 84 to the CD-ROM device. The CD-ROM device transfers 85 data to a buffer. The CD-ROM device signals 86 completion of the task. The Int 13h function 42 call returns 92 a command complete signal. The read block X command returns 87 a complete signal.

When the system firmware including the abstraction layer 65 boots a removable media device, such as a CD-ROM, DVD or magneto-optical device, it uses Int 13 functions 1-3Fh to provide an abstraction layer 65 that allows the disk operating system to see (access) the removable media device as a floppy drive. Thus, the Int 13 functions 1-3Fh operate to simulate the floppy drive as an A: drive, for example.

The Int 13 functions 40h and above are used to access the removable media device in its native mode while the A: drive simulation is maintained. Thus, two drive letters are associated with the removable media device, which include A: as the boot drive letter, and another letter, D: for example, exposing the data on the removable media.

Operationally, CD-ROM, DVD, magneto-optical, or other media that is booted on a computer system employing the present invention, that has an installed driver that uses the abstraction layer 65 in accordance with the present invention to access the media, will be able to offer all of its contents to an operating system or other program. Using the principles of the present invention, a bootable recovery CD, for example, may be produced that is operational regardless of the bus interface to which the CD-ROM device is coupled. If the computer system supports booting from the bus interface, the recovery CD will work. This is because the boot volume descriptor will have been found during boot process.

In summary, there are several new capabilities provided by the present invention. The present invention provides the abstraction layer 65 for accessing a removable media device, such as CD-ROM or DVD drive, regardless of the bus interface. The present invention uses a generic removable media device driver that calls the abstraction layer 65. The present invention provides for system firmware that implements two different types of services (emulation and raw access) simultaneously on a single media.

The present invention allows a CD-ROM, DVD, magneto-optical, or other removable media device to boot from an operating system contained on the media and then provide access to all the data on the media, regardless of the (primary or secondary) bus interface. The primary bus interface may be a USB™ (Universal Serial Bus), IEEE-1394 bus, Bluetooth (short-range radio technology), ATA (AT Attachment), ATAPI, or SCSI (small computer system interface) bus. The secondary interface bus may be PCI® (Peripheral Component Interconnect), Infiniband™ , USB™ , or IEEE-1394bus.

Thus, apparatus and methods that use an abstraction layer to control a removable media device coupled to a computer system have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A method for controlling a removable media device coupled to a computer system by way of a bus interface, the computer system having system firmware, the method comprising the step of:
providing one or more abstraction layers in the system firmware that employ interrupt 13 functions to allow a program to communicate with the removable media device.

2. The method recited in claim 1 wherein the removable media employed with the removable media device comprises a device driver that calls the abstraction layer in the system firmware.

3. The method recited in claim 1 wherein the removable media is used to perform recovery of contents of a device coupled to the computer.

4. The method recited in claim 2 wherein the removable media is used to perform recovery of contents of a device coupled to the computer.

5. The method recited in claim 1 wherein the removable media device is selected from the group including a CD-ROM device, a DVD device, or a magneto-optical device.

6. The method recited in claim 1 wherein the program comprises an operating system or application.

7. The method recited in claim 1 wherein the abstraction layer comprises interrupt 13 functions 40b and above that allow the program to access the removable media device in its native mode.

8. The method recited in claim 7 wherein the abstraction layer comprises interrupt 13 functions 1-3Fh that allow the program to access the removable media device as a floppy drive.

9. The method recited in claim 1 wherein the bus interface is selected from the group including a Universal Serial Bus (USB™), an IEEE-1394 bus, a Bluetooth™ bus, an ATA bus, an ATAPI bus, Peripheral Component Interconnect (PCI®) bus, Infiniband™ bus, or a SCSI bus.

10. Apparatus comprising:
a computer comprising system firmware and a removable media device; and
wherein the system firmware includes one or more abstraction layers that employ interrupt 13 functions to allow a program to communicate with the removable media device.

11. The apparatus recited in claim 10 wherein the removable media employed with the removable media device comprises a device driver that calls the abstraction layer in the system firmware.

12. The apparatus recited in claim 10 wherein the removable media is used to perform recovery of contents of a device coupled to the computer.

13. The apparatus recited in claim 12 wherein the removable media is used to perform recovery of contents of a device coupled to the computer.

14. The apparatus recited in claim 10 wherein the removable media device is selected from the group including a CD-ROM device, a DVD device, or a magneto-optical device.

15. The apparatus recited in claim 10 wherein the program comprises an operating system or application.

16. The apparatus recited in claim 10 wherein the abstraction layer comprises interrupt 13 functions 40h and above that allow the program to access the removable media device in its native mode.

17. The apparatus recited in claim 16 wherein the abstraction layer comprises interrupt 13 functions 1-3Fh that allow the program to access the removable media device as a floppy drive.

18. The apparatus recited in claim 10 wherein the bus interface is selected from the group including a Universal Serial Bus (USB™), an IEEE-1394 bus, a Bluetooth∩ bus, an ATA bus, an ATAPI bus, Peripheral Component Interconnect (PCI®) bus, Infiniband™ bus, or a SCSI bus.
